(19) United States
(12) Patent Application Publication
(10) Pub. No.: US 2003/0011878 A1
(43) Pub. Date: Jan. 16, 2003

(54) Remote pumping of optical amplifier system and method

(76) Inventor: Steven J. Maas, Austin, TX (US)

Correspondence Address: PGS Americas Inc, 16010 Baker's Point Lane, Suite 300, Houston, TX, 77079, US

(21) Appl. No.: 09/902,559

(22) Filed: Jul. 11, 2001

(51) Int. Cl. H01S 3/00

(52) U.S. Cl. 359/341.3

(57) ABSTRACT

Several embodiments of an apparatus for remote amplification of seismic sensor fiber optical signals from seismic sensor arrays are disclosed. The seismic sensor fiber optical signals are transmitted using FDM/WDM and TDM/WDM techniques. Embodiments of the invention allow for modular structure of the seismic sensor arrays, wherein the excess of the pumped optical energy is used to amplify another module of the sensor arrays. The sensor arrays can be arranged in serial and/or parallel configuration. An embodiment of the invention allows for repeated amplification of the seismic sensor fiber optical signals using pumped optical energy from a single source. In another aspect of the invention, systems corresponding to the apparatus and methods of using the systems are disclosed.

### BACKGROUND OF THE INVENTION

The present invention relates to optical amplifiers and specifically to fiber optic telemetry systems and methods.

In a typical configuration for an optical amplifier, an optical signal feeds a piece of doped optical fiber, the dopant ions in the fiber being excited by a pump signal into the fiber. As the signal enters the amplifier, the energy from the excited dopant ions is transferred into photons at the signal wavelength. In addition, in many typical configurations the signal for the optical amplifiers is sent with circulators integral to the amplifier. In such amplifier configurations, however, individual pump diodes are resident at each optical amplifier.

Seismic sensor arrays typically extend over long distances, sometimes several miles. An economic approach to sensing the seismic arrays is through fiber optic telemetry schemes. Many times, however, the optical loss associated with these telemetry schemes is excessive and results in a problem regarding optical signal attenuation. That is, optical signal attenuation may become significant over long distances, and the signal requires optical amplifiers to make up for the propagation signal loss. Multiple stages of amplification are added to accommodate all of the fibers in an array along the signal path in order to increase the signal to noise ratio. In addition, to achieve multiple amplifications, conventional practice requires an individual pump diode resident at each amplifier.

Accordingly, there is a need for a system and method for amplifying a signal that avoids the need for individual pump diodes at each optical amplifier. It is an object of the present invention to address the above-described needs.

### SUMMARY OF THE INVENTION

The above needs are addressed, according to one example embodiment of the invention, by providing an amplification method and system that uses remote optical pumping of multiple stages of amplification with a single pump line. In some embodiments, a single pump fiber is used with multiple amplifiers on many telemetry lines. In other embodiments, multiple amplifiers are used on a single telemetry line.

In one aspect of the invention, a method is provided for amplifying optical sensor signals, the method comprising: pumping a first optical amplifier, located in a seismic cable, with a pumping source; feeding a first optical signal to the first optical amplifier; pumping a second optical amplifier, located in the seismic cable, with the pumping source; and feeding a second optical signal to the second optical amplifier.

In another of the invention, a system is provided for amplifying optical sensor signals, the system comprising: means for pumping a first optical amplifier, located in a seismic cable, with a pumping source; means for feeding a first optical signal to the first optical amplifier; means for pumping a second optical amplifier, located in the seismic cable, with the pumping source; and means for feeding a second optical signal to the second optical amplifier.

In a further aspect of the invention, an apparatus for remote amplification of at least one optical sensor signal is provided. In one example embodiment, the apparatus comprises at least one amplification section, wherein the at least one amplification section comprises a first wavelength-selective coupler having a first coupler first side and a first coupler second side, the first coupler first side further comprising an optical pump input port adapted to receive an optical pump input, and a signal output port adapted to output an amplified optical sensor signal, and the first coupler second side having a first coupler optical amplifier connection port. The apparatus further comprises an optical amplifier having an amplifier first port and an amplifier second port, wherein the amplifier first port is coupled to the first coupler optical amplifier connection port. Further still, the apparatus comprises a second wavelength-selective coupler having a second coupler first side and a second coupler second side, the second coupler first side optically coupled to the amplifier second port, and the second coupler second side further comprising a second coupler signal input port and an optical pump tap out port, wherein the second coupler signal input port is adapted to receive one of the at least one optical sensor signal input, and the optical pump tap out port is adapted to output an excess optical pump energy to another amplification section.

According to another aspect of the present invention, an apparatus for remote multistage amplification of a optical sensor signal is provided. In one example embodiment, the apparatus comprises a first wavelength-selective coupler having a first coupler first side and a first coupler second side, wherein the first coupler first side further comprising a first coupler optical pump input port adapted to receive an optical pump input, and a first coupler signal output port adapted to output an amplified optical sensor signal, and the first coupler second side having a first coupler optical amplifier connection port; a first optical amplifier having a first amplifier first port and a first amplifier second port, wherein the first amplifier first port is coupled to the first coupler optical amplifier connection port. The apparatus further comprises a second wavelength-selective coupler having a second coupler first side and a second coupler second side, wherein the second coupler first side is optically coupled to the first amplifier second port, and the second coupler second side further comprising a second coupler signal input port and a second coupler optical pump output port, wherein the second coupler signal input port is adapted to receive an amplified optical sensor signal input, and the second coupler optical pump output port is adapted to output a first excess optical pump energy. The apparatus further comprises a third wavelength-selective coupler having a third coupler first side and a third coupler second side, wherein the third coupler first side further comprising a third coupler signal output port, and a third coupler optical pump energy input port, and wherein the third coupler optical pump energy input port optically coupled to the second coupler optical pump output port, and the third coupler second side further comprising a third coupler signal input port; a second optical amplifier having a second amplifier first port and a second amplifier second port, wherein the second amplifier first port is coupled to the third coupler signal input port. Further still, the apparatus comprises a fourth wavelength-selective coupler having a fourth coupler first side and a fourth coupler second side, wherein the fourth coupler first side is optically coupled to the second amplifier second port, and the fourth coupler second side further comprising a fourth coupler signal input port and a fourth coupler optical pump output port, wherein the fourth coupler signal input port is adapted to receive a optical sensor signal input, and the fourth coupler optical pump output port is adapted to output a second excess optical pump energy.

According to still another aspect of the present invention, an apparatus for remote amplification a plurality of optical sensor signals in a parallel configuration using an optical pump is provided. In an example embodiment, the apparatus comprises: a first wavelength-selective coupler having a first coupler first side and a first coupler second side, wherein the first coupler first side further comprising a first coupler optical pump input port coupled to an optical pump, and a first coupler signal output port adapted to output a first amplified optical sensor signal, and the first coupler second side having a first coupler optical amplifier connection port. The apparatus further comprises a first optical amplifier having a first amplifier first port and a first amplifier second port, wherein the first amplifier first port is coupled to the first coupler optical amplifier connection port, and the first amplifier second port adapted to receive a first optical sensor signal input. The apparatus further still comprises a second wavelength-selective coupler having a second coupler first side and a second coupler second side, wherein the second coupler first side further comprising a second coupler optical pump input port coupled to the optical pump, and a second coupler signal output port adapted to output a second amplified optical sensor signal, and the second coupler second side having a second coupler optical amplifier connection port; and a second optical amplifier having a second amplifier first port and a second amplifier second port, wherein the second amplifier first port is coupled to the second coupler optical amplifier connection port, and the second amplifier second port adapted to receive a second optical sensor signal input, wherein a second amplified optical sensor signal results.

In a still another aspect of the invention, a method of amplifying optical sensor signals is provided. The method comprises pumping a first optical amplifier, located in a seismic cable, with a pumping source, and feeding a first optical signal to the first optical amplifier. The method further comprises pumping a second optical amplifier, located in the seismic cable, with the same pumping source, and feeding a second optical signal to the second optical amplifier.

In another aspect of the invention, a system for amplifying optical sensor signals is provided. The system comprises a means for pumping a first optical amplifier, located in a seismic cable, with a pumping source, and a means for feeding a first optical signal to the first optical amplifier. The system further comprises a means for pumping a second optical amplifier, located in the seismic cable, with the same pumping source, and a means for feeding a second optical signal to the second optical amplifier.

### BRIEF DESCRIPTION OF THE DRAWINGS

FIG. 1 shows an example embodiment of the present invention for an apparatus having remote optical signal amplification in a series configuration.

FIG. 2 shows an example embodiment of the present invention for an apparatus having remote multistage optical signal amplification.

FIG. 3 shows an example embodiment of the present invention for an apparatus having remote optical signal amplification in parallel configuration.

FIG. 4 shows example embodiments of the present invention for systems involving amplifying optical sensor signals with the same pump source.

FIG. 5 shows example embodiments of the present invention for systems involving amplifying optical sensor signals with telemetry lines feeding optical signals from seismic arrays to optical amplifiers.

FIG. 6 shows example embodiments of the present invention for systems involving splitting a pump signal before amplifying optical sensor signals with the same pump source.

FIG. 7 shows example embodiments of the present invention for systems involving feeding optical signals through separate lines to optical amplifiers, that is, a one to one ratio between lines and amplifiers.

### DETAILED DESCRIPTION OF EXEMPLARY EMBODIMENTS

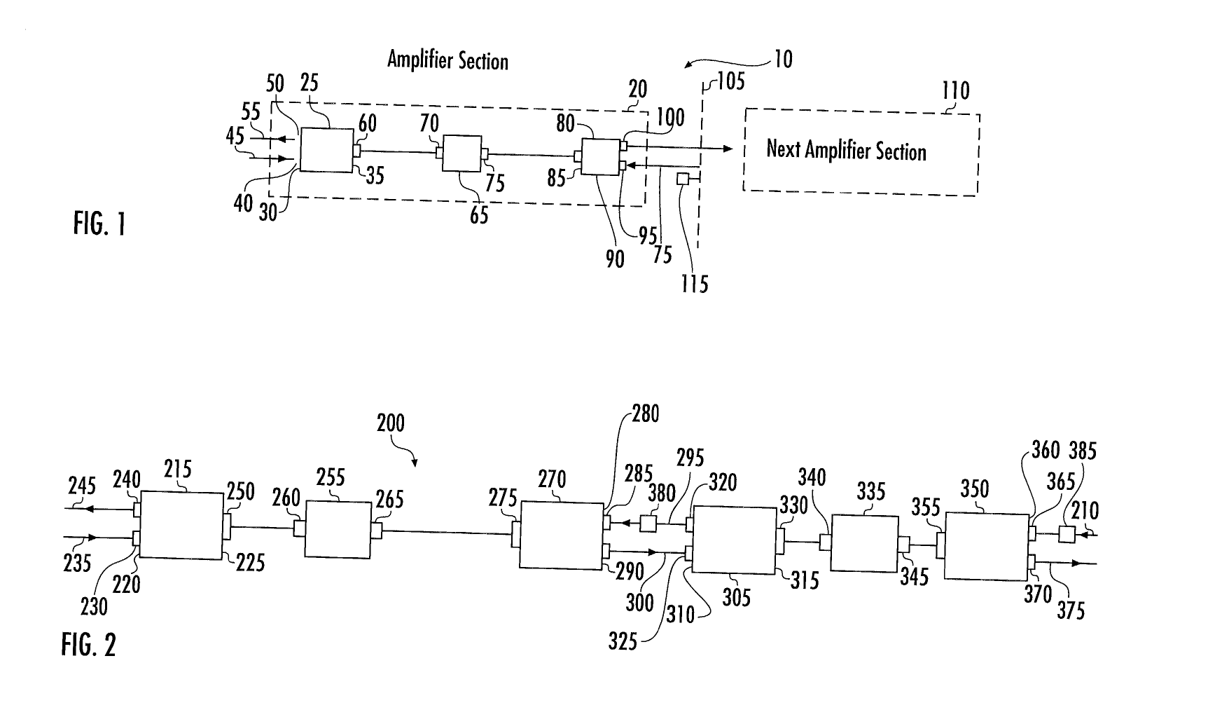

Referring now to FIG. 1, an example embodiment of the invention is seen in which an apparatus 10 for remote amplification of at least one optical sensor signal 15 is provided. Applications of embodiments include seismic sensing, down-hole logging, and many other applications as will occur to those of skill in the art. According to the illustrated embodiment, the apparatus 10 comprises at least one amplification section 20, wherein the at least one amplification section 20 comprises: a first wavelength-selective coupler 25 having a first coupler first side 30 and a first coupler second side 35, the first coupler first side 30 further comprising an optical pump input port 40, adapted to receive an optical pump input 45, and a signal output port 50 adapted to output an amplified optical sensor signal 55. The first coupler second side 35 includes a first coupler optical amplifier connection port 60 and an optical amplifier 65 having an amplifier first port 70 and an amplifier second port 75, wherein the amplifier first port 70 is coupled to the first coupler optical amplifier connection port 60. A second wavelength-selective coupler 80 is also seen, having a second coupler first side 85 and a second coupler second side 90. The second coupler first side 85 is optically coupled to the amplifier second port 75.

The second coupler second side 90 further comprises a second coupler signal input port 95 and an optical pump tap out port 100, wherein the second coupler signal input port 95 is adapted to receive at least one optical sensor signal 15 inputs, and the optical pump tap out port 100 is adapted to output an excess optical pump energy 105 to another amplification section 110.

Still referring to the example embodiment of FIG. 1, the at least one amplification section 20 comprises a plurality of amplification sections coupled to each other in a cascaded manner, wherein each amplification section 20 is adapted to receive one optical sensor signal input 15, output one optical sensor signal output 55, and output one excess optical pump energy 105 to an adjacent amplification section 110. In another embodiment, the first wavelength-selective coupler 25 comprises a WDM coupler. In a still another embodiment, the second wavelength-selective coupler 80 comprises a WDM coupler. In a still further embodiment, the optical amplifier 65 comprises an erbium doped optical amplifier. In a yet another embodiment, the second coupler signal input port further comprises an optical isolator 115. In a still another embodiment, the optical isolator 115 is integral to the second coupler signal input port 95.

In additional specific embodiments, the excess optical pump energy 105 is used to provide optical pump energy to the optical pump input port of a next amplification section 110. Similarly, the process of providing left over optical pump energy to the adjacent amplification section is continued. Design of the apparatus 10 provides unique advantage of modular construction of seismic sensor arrays in which the amplification sections are connected serially according to the requirements in the field and provided with remote optical pumping from a single optical pump.

Now referring to FIG. 2, another example embodiment of the invention is seen in which an apparatus 200 is provided for remote multistage amplification of a optical sensor signal 210. According to the illustrated embodiment, the apparatus 200 comprises: a first wavelength-selective coupler 215 having a first coupler first side 220 and a first coupler second side 225, wherein the first coupler first side 220 further comprises a first coupler optical pump input port 230 adapted to receive an optical pump input 235, and a first coupler signal output port 240 adapted to output an amplified optical sensor signal 245. The first coupler second side 225 includes a first coupler optical amplifier connection port 250 and a first optical amplifier 255, having a first amplifier first port 260 and a first amplifier second port 265, wherein the first amplifier first port 260 is coupled to the first coupler optical amplifier connection port 250. A second wavelength-selective coupler 270 is provided having a second coupler first side 275 and a second coupler second side 280, wherein the second coupler first side 275 is optically coupled to the first amplifier second port 265. The second coupler second side 280 further comprises a second coupler signal input port 285 and a second coupler optical pump output port 290, wherein the second coupler signal input port 285 is adapted to receive an amplified optical sensor signal 295 input. Further, the second coupler optical pump output port 290 is adapted to output a first excess optical pump energy 300. A third wavelength-selective coupler 305 includes a third coupler first side 310 and a third coupler second side 315, wherein the third coupler first side 310 further comprises a third coupler signal output port 320, and a third coupler optical pump energy input port 325. The third coupler optical pump energy input port 325 is optically coupled to the second coupler optical pump output port 290, and the third coupler second side 315 further comprises a third coupler signal input port 330. A second optical amplifier 335 is provided and includes a second amplifier first port 340 and a second amplifier second port 345, wherein the second amplifier first port 340 is coupled to the third coupler signal input port 330. Fourth wavelength-selective coupler 350 has a fourth coupler first side 355 and a fourth coupler second side 360, wherein the fourth coupler first side 355 is optically coupled to the second amplifier second port 345, and the fourth coupler second side 360 further comprises a fourth coupler signal input port 365 and a fourth coupler optical pump output port 370. The fourth coupler signal input port 365 is adapted to receive a optical sensor signal 210 input, and the fourth coupler optical pump output port 370 is adapted to output a second excess optical pump energy 375.

Again referring to FIG. 2, in one of the embodiments of the invention, the first wavelength-selective coupler 215 comprises a WDM coupler. In another embodiment, the first optical amplifier comprises 255 an erbium doped optical amplifier. In a still another embodiment, the second wavelength-selective coupler 270 comprises a WDM coupler. In a still further embodiment, the second coupler signal input port 285 further comprises a first optical isolator 380. In a yet still further embodiment, the first optical isolator 380 is integral to the second coupler signal input port 285. In a yet further embodiment, the third wavelength-selective coupler 305 comprises a WDM coupler. In a still other embodiment, the second optical amplifier 335 comprises an erbium doped optical amplifier. In another aspect of the embodiment, the fourth wavelength-selective coupler 350 comprises a WDM coupler. In a yet another aspect of the embodiment, the fourth coupler signal input port 365 further comprises a second optical isolator 385. In a still yet another aspect of the embodiment, the second optical isolator 385 is integral to the fourth coupler signal input port 365.

Note that the second excess optical pump energy 375 is used, in some embodiments, to provide optical pump energy to the optical pump input port of a next signal amplification module that is similar to the apparatus 200. Likewise, the process of providing left over optical pump energy to the adjacent amplification module that is similar to the apparatus 200 is continued in other embodiments. Design of the apparatus 200 provides unique advantage of modular construction of seismic sensor arrays in which the amplification modules can be connected serially according to the requirements in the field and provided with remote optical pumping from a single optical pump.

Referring now to FIG. 3, another example embodiment of the apparatus 400 for remote amplification of a plurality of optical sensor signals 410 and 415 in a parallel configuration using an optical pump 420 is seen. Here, the apparatus 400 comprises: a first wavelength-selective coupler 425 having a first coupler first side 430 and a first coupler second side 435, wherein the first coupler first side 430 further comprises a first coupler optical pump input port 440 coupled to an optical pump 420, and a first coupler signal output port 445 adapted to output a first amplified optical sensor signal 450. The first coupler second side 435 has a first coupler optical amplifier connection port 450. First optical amplifier 455 includes a first amplifier first port 460 and a first amplifier second port 465, wherein the first amplifier first port 460 is coupled to the first coupler optical amplifier connection port 450, and the first amplifier second port 465 adapted to receive a first optical sensor signal 410 input. Second wavelength-selective coupler 470 comprises a second coupler first side 475 and a second coupler second side 480, wherein the second coupler first side 475 further comprises a second coupler optical pump input port 485 coupled to the optical pump 420, and a second coupler signal output port 490 adapted to output a second amplified optical sensor signal 495, and the second coupler second side 480 has a second coupler optical amplifier connection port 500. Second optical amplifier 505 includes a second amplifier first port 510 and a second amplifier second port 515, wherein the second amplifier first port 510 is coupled to the second coupler optical amplifier connection port 500, and the second amplifier second port 515 adapted to receive a second optical sensor signal 415 input.

Referring still to FIG. 3, in one embodiment of the invention, the first wavelength-selective coupler 425 comprises a WDM coupler. In another embodiment, the first optical amplifier 455 comprises an erbium doped optical amplifier. In a yet another embodiment, the first amplifier second port 465 further comprises a first optical isolator 520. In a still yet another embodiment, the first optical isolator 520 is integral to the first amplifier second port 465. In a further yet another embodiment, the second wavelength-selective coupler 470 comprises a WDM coupler. In a still another embodiment, the second optical amplifier 505 comprises an erbium doped optical amplifier. In another aspect of the embodiment, the second amplifier second port 515 further comprises a second optical isolator 525. In a still another aspect of the embodiment, the second optical isolator 525 is integral to the second amplifier second port 515.

Note that in embodiments of FIG. 3, any number of branches, within the of capabilities of the hardware used, are arranged in a parallel configuration to remotely amplify optical sensor signals using a single optical pump, wherein branches in the parallel configuration provide a modular structure of the apparatus 400.

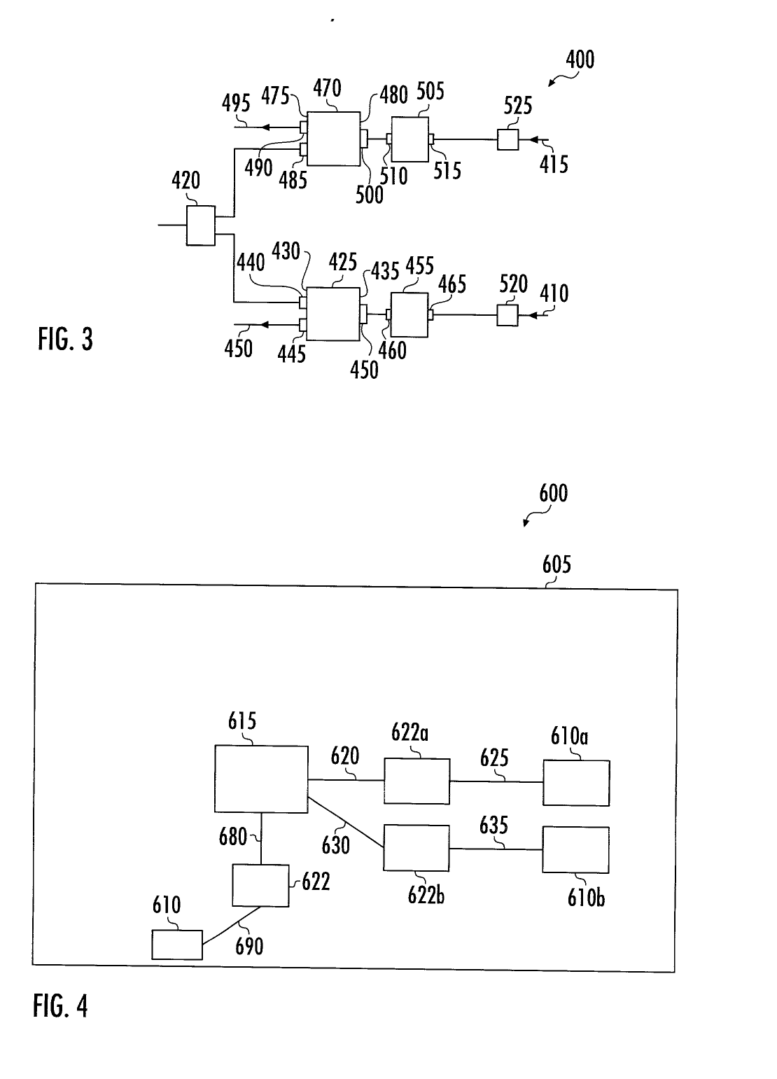

Referring now to FIG. 4, further example embodiments of the invention are depicted, wherein a system 600 for amplifying optical sensor signals 610a, 610b is disclosed. The system 600 comprises a means 620 for pumping a first optical amplifier 622a, located in a seismic cable 605, with a pumping source 615, and a means 625 for feeding a first optical signal 610a to the first optical amplifier 622a. The system 600 further comprises a means 630 for pumping a second optical amplifier 622b, located in the seismic cable 605, with the pumping source 615, and a means 635 for feeding a second optical signal 610b to the second optical amplifier 622b. The pumping of the optical amplifiers 622a, 622b with a pump signal 622 from the pump source 615 shared by all optical amplifiers 622a, 622b excites the ions in the optical amplifiers 622a, 622b. Typically, the ions are erbium ions in the doped fiber coils of the optical amplifiers 622a, 622b, and the pump source 615 exciting these erbium ions is sent through cabling, telemetry lines, or the like, as is seen in FIG. 5.

Turning to FIG. 5 then, another example embodiment of the invention is the system 600 previously described, wherein the means (FIG. 4, reference 625) for feeding the first optical signal 610a comprises means for feeding the first optical signal 610a through a first telemetry line 642, and the means (FIG. 4, reference 635) for feeding the second optical signal 610b comprises feeding the second optical signal 610b through a second telemetry line 652. Other methods and means for feeding optical signals will occur to those of skill in the art that do not depart from the spirit of the claimed invention.

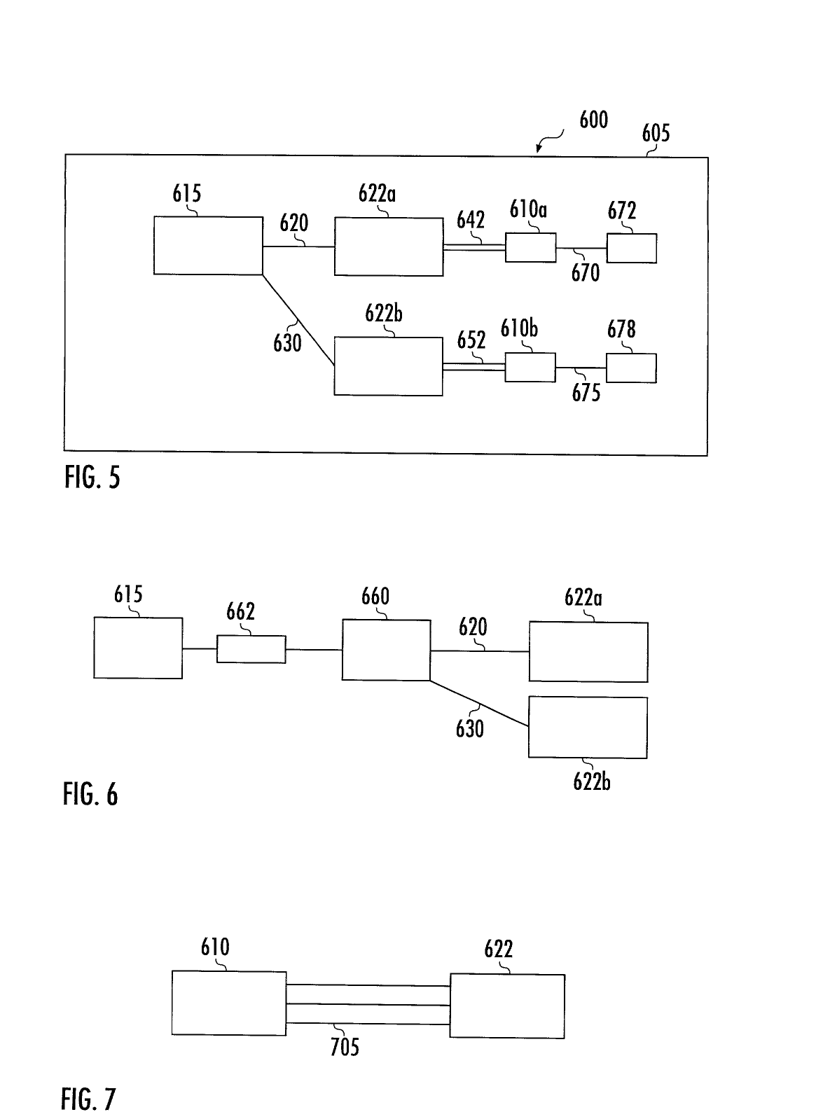

Referring to FIG. 6, another example embodiment of the invention is the system 600 previously described and further comprising a means 660 for splitting a pump signal 662 from the pumping source 615 before the means 620 for pumping the first optical amplifiers 622a and before the means 630 for pumping the second optical amplifier 622b. Rather than using the described method and system in a series configuration, whether a cascading or in-line series configuration, splitting the pump signal 662 is ideal for use of the disclosed methods and systems in a parallel configuration. Joining two separate telemetry lines (642, 652 on FIG. 5), wherein each telemetry line (642, 652 on FIG. 5) has its own input optical signals (610a, 610b on FIG. 5), is a coupler, such as a WDM coupler. But even before the WDM coupler, a pump demultiplexer 660 splits out the pump signal 662 from the same pump source 615 so that each telemetry line 620, 630 has its own pump signal 662 to excite an optical amplifier 622a, 622b, and thereby, produce amplified optical signals.

Turning back to FIG. 5, another example embodiment of the invention is seen, wherein the system 600 further comprises a means 670 for receiving the first optical signal 610a from a first seismic sensor array 672, and means 675 for receiving the second optical signal 610b from a second seismic sensor array 678. For example, methods and means 670, 675 for receiving optical signals 610a, 610b from arrays 672, 678 include through cabling, lines or the like.

Referring to FIG. 4 again, more example embodiments of the invention are shown. In one example embodiment, the system 600 further comprises a means 680 for pumping additional optical amplifiers 622 with the pumping source 615. That is, the previously described methods and systems are not limited to two optical amplifiers 622a, 622b, two optical signals 610a, 610b, and so forth. Rather, the invention is remote amplification of many optical signals 610 using the same pump source 615 for multiple amplifiers 622. In still another example embodiment, the system 600 further comprises a means 690 for feeding additional optical signals 610 to additional optical amplifiers 622. And in FIG. 7, another example embodiment is illustrated, wherein the means (690 on FIG. 4) for feeding additional optical signals 610 comprises through separate telemetry lines 705. That is, for example, a method or system employing twenty optical amplifiers 622, then twenty telemetry lines 705 are used wherein each telemetry line 705 is connected to its own optical amplifier 622, feeds its own optical amplifier 622, but all twenty optical amplifiers 622 share the same pump source (615 on FIG. 4) for exciting the fibers of the optical amplifiers 622.

The various means described in reference to the later Figures will be understood and will occur to those of ordinary skill in the art from a review of the earlier disclosure, and the specific examples of the various drawings.

Having thus described exemplary embodiments of the invention, it will be apparent that various alterations, modifications and improvements will readily occur to those skilled in the art. Such obvious alterations, modifications and improvements, though not expressly described above, are nevertheless intended to be implied and are within the spirit and scope of the invention. Accordingly, the foregoing discussion is intended to be illustrative only, and not limiting; the invention is limited and defined by the following claims and equivalents thereto.

What is claimed is:

1. An apparatus for remote amplification of at least one optical sensor signal, the apparatus comprising at least one amplification section, the at least one amplification section comprising:
a first wavelength-selective coupler having a first coupler first side and a first coupler second side, the first coupler first side further comprising an optical pump input port adapted to receive an optical pump input, and a signal output port adapted to output an amplified optical sensor signal, and the first coupler second side having a first coupler optical amplifier connection port;
an optical amplifier comprising an amplifier first port and an amplifier second port, wherein the amplifier first port is coupled to the first coupler optical amplifier connection port; and
a second wavelength-selective coupler having a second coupler first side and a second coupler second side, the second coupler first side optically coupled to the amplifier second port, and the second coupler second side further comprising a second coupler signal input port and an optical pump tap out port, wherein the second coupler signal input port is adapted to receive one of the at least one optical sensor signal input, and the optical pump tap out port is adapted to output an excess optical pump energy to another amplification section.

2. An apparatus as in claim 1, wherein the at least one amplification section comprises a plurality of amplification sections, wherein each amplification section is adapted to receive one optical sensor signal input, output one optical sensor signal output and output one excess optical pump energy to an adjacent amplification section.

3. An apparatus as in claim 1, wherein the first wavelength-selective coupler comprises a WDM coupler.

4. An apparatus as in claim 1, wherein the second wavelength-selective coupler comprises a WDM coupler.

5. An apparatus as in claim 1, wherein the optical amplifier comprises an erbium doped optical amplifier.

6. An apparatus as in claim 1, wherein the second coupler signal input port further comprises an optical isolator.

7. An apparatus as in claim 6, wherein the optical isolator is integral to the second coupler signal input port.

8. An apparatus as in claim 1 wherein the optical sensor signal comprises a seismic optical sensor signal, and the amplified sensor optical signal comprises an amplified seismic optical sensor signal.

9. An apparatus for remote multistage amplification of a optical sensor signal, the apparatus comprising:
a first wavelength-selective coupler having a first coupler first side and a first coupler second side, wherein the first coupler first side further comprises a first coupler optical pump input port adapted to receive an optical pump input, and a first coupler signal output port adapted to output an amplified optical sensor signal, and the first coupler second side having a first coupler optical amplifier connection port;
a first optical amplifier having a first amplifier first port and a first amplifier second port, wherein the first amplifier first port is coupled to the first coupler optical amplifier connection port;
a second wavelength-selective coupler having a second coupler first side and a second coupler second side, wherein the second coupler first side is optically coupled to the first amplifier second port, and the second coupler second side further comprises a second coupler signal input port and a second coupler optical pump output port, wherein the second coupler signal input port is adapted to receive an amplified optical sensor signal input, and the second coupler optical pump output port is adapted to output a first excess optical pump energy;
a third wavelength-selective coupler having a third coupler first side and a third coupler second side, wherein the third coupler first side further comprises a third coupler signal output port, and a third coupler optical pump energy input port, and wherein the third coupler optical pump energy input port optically coupled to the second coupler optical pump output port, and the third coupler second side further comprising a third coupler signal input port;
a second optical amplifier having a second amplifier first port and a second amplifier second port, wherein the second amplifier first port is coupled to the third coupler signal input port; and
a fourth wavelength-selective coupler having a fourth coupler first side and a fourth coupler second side, wherein the fourth coupler first side is optically coupled to the second amplifier second port, and the fourth coupler second side further comprises a fourth coupler signal input port and a fourth coupler optical pump output port, wherein the fourth coupler signal input port is adapted to receive a optical sensor signal input, and the fourth coupler optical pump output port is adapted to output a second excess optical pump energy.

10. An apparatus as in claim 9, wherein the first wavelength-selective coupler comprises a WDM coupler.

11. An apparatus as in claim 9, wherein the first optical amplifier comprises an erbium doped optical amplifier.

12. An apparatus as in claim 9, wherein the second wavelength-selective coupler comprises a WDM coupler.

13. An apparatus as in claim 9, wherein the second coupler signal input port further comprises a first optical isolator.

14. An apparatus as in claim 13, wherein the first optical isolator is integral to the second coupler signal input port.

15. An apparatus as in claim 9, wherein the third wavelength-selective coupler comprises a WDM coupler.

16. An apparatus as in claim 9, wherein the second optical amplifier comprises an erbium doped optical amplifier.

17. An apparatus as in claim 9, wherein the fourth wavelength-selective coupler comprises a WDM coupler.

18. An apparatus as in claim 9, wherein the fourth coupler signal input port further comprises a second optical isolator.

19. An apparatus as in claim 18, wherein the second optical isolator is integral to the fourth coupler signal input port.

20. An apparatus for remote amplification of a plurality of optical sensor signals in a parallel configuration using an optical pump, the apparatus comprising:
a first wavelength-selective coupler having a first coupler first side and a first coupler second side, wherein the first coupler first side further comprises a first coupler optical pump input port coupled to an optical pump, and a first coupler signal output port adapted to output a first amplified optical sensor signal, and the first coupler second side having a first coupler optical amplifier connection port;
a first optical amplifier having a first amplifier first port and a first amplifier second port, wherein the first amplifier first port is coupled to the first coupler optical amplifier connection port, and the first amplifier second port adapted to receive a first optical sensor signal input;
a second wavelength-selective coupler having a second coupler first side and a second coupler second side, wherein the second coupler first side further comprises a second coupler optical pump input port coupled to the optical pump, and a second coupler signal output port adapted to output a second amplified optical sensor signal, and the second coupler second side having a second coupler optical amplifier connection port; and
a second optical amplifier having a second amplifier first port and a second amplifier second port, wherein the second amplifier first port is coupled to the second coupler optical amplifier connection port, and the second amplifier second port adapted to receive a second optical sensor signal input.

21. An apparatus as in claim 20, wherein the first wavelength-selective coupler comprises a WDM coupler.

22. An apparatus as in claim 20, wherein the first optical amplifier comprises an erbium doped optical amplifier.

23. An apparatus as in claim 20, wherein the first amplifier second port further comprises a first optical isolator.

24. An apparatus as in claim 23, wherein the first optical isolator is integral to the first amplifier second port.

25. An apparatus as in claim 20, wherein the second wavelength-selective coupler comprises a WDM coupler.

26. An apparatus as in claim 20, wherein the second optical amplifier comprises an erbium doped optical amplifier.

27. An apparatus as in claim 20, wherein the second amplifier second port further comprises a second optical isolator.

28. An apparatus as in claim 27, wherein the second optical isolator is integral to the second amplifier second port.

29. A method for amplifying optical sensor signals, the method comprising:
pumping a first optical amplifier, located in a seismic cable, with a pumping source;
feeding a first optical signal to the first optical amplifier;
pumping a second optical amplifier, located in the seismic cable, with the pumping source; and
feeding a second optical signal to the second optical amplifier.

30. The method of claim 29, wherein the feeding the first optical signal comprises through a first telemetry line, and the feeding the second optical signal comprises through a second telemetry line.

31. The method of claim 29, wherein the method further comprises splitting a pump signal from the pumping source before the pumping the first optical amplifiers and before the pumping the second optical amplifier.

32. The method of claim 29, wherein the method further comprises receiving the first optical signal from a first seismic sensor array section, and receiving the second optical signal from a second seismic sensor array section.

33. The method of claim 29, wherein the method further comprises pumping additional optical amplifiers with the pumping source.

34. The method of claim 29, wherein the method further comprises feeding additional optical signals to additional optical amplifiers.

35. The method of claim 34, wherein the feeding additional optical signals comprises through separate telemetry lines.

36. A system for amplifying optical sensor signals, the system comprising:
means for pumping a first optical amplifier, located in a seismic cable, with a pumping source;
means for feeding a first optical signal to the first optical amplifier;
means for pumping a second optical amplifier, located in the seismic cable, with the pumping source; and
means for feeding a second optical signal to the second optical amplifier.

37. The system of claim 36, wherein the means for feeding the first optical signal comprises through a first telemetry line, and the means for feeding the second optical signal comprises through a second telemetry line.

38. The system of claim 36, wherein the system further comprises means for splitting a pump signal from the pumping source before the means for pumping the first optical amplifiers and before the means for pumping the second optical amplifier.

39. The system of claim 36, wherein the system further comprises means for receiving the first optical signal from a first seismic sensor array, and means for receiving the second optical signal from a second seismic sensor array.

40. The system of claim 36, wherein the system further comprises means for pumping additional optical amplifiers with the pumping source.

41. The system of claim 36, wherein the system further comprises means for feeding additional optical signals to additional optical amplifiers.

42. The system of claim 41, wherein the means for feeding additional optical signals comprises through separate telemetry lines.
